(19) United States
(12) Patent Application Publication
(10) Pub. No.: US 2009/0103465 A1
(43) Pub. Date: Apr. 23, 2009

(54) SYNCHRONIZED MULTI-BS MBS FOR IMPROVED IDLE MODE POWER SAVINGS IN HIGHER-ORDER FREQUENCY REUSE NETWORKS

(76) Inventors: Jerry CHOW, San Diego, CA (US); Tricci SO, San Diego, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/253,184

(22) Filed: Oct. 16, 2008

Related U.S. Application Data
(60) Provisional application No. 60/981,455, filed on Oct. 19, 2007.

(51) Int. Cl. H04H 20/71

(52) U.S. Cl. 370/312

(57) ABSTRACT

A method for providing a multicast and broadcast service (MBS) in a wireless network, the method comprising: establishing an MBS MAC connection between a mobile station (MS) and a first base station (BS) in an MBS zone; sending a first MBS_MAP message in a first frame, wherein the first MBS_MAP message includes information for locating a second MBS_MAP message in a second frame, but does not specify the location of the second MBS MAP message within the second frame; and sending the second MBS_MAP message in the second frame.

### RELATED PATENT APPLICATIONS

This application claims benefit of priority under 35 U.S.C. §119(e) to Provisional Application No. 60/981,455, entitled “Synchronized Multi-BS MBS for Improved Idle Mode Power Savings in Higher-Order Frequency Reuse Networks”, filed Oct. 19, 2007, which is incorporated by reference herein in its entirety.

### BACKGROUND OF THE INVENTION

1. Field of the Invention

This invention relates to wireless networks, and more particularly, to a system and method for providing a multicast and broadcast service (MBS) in a WiMAX network.

2. Discussion of Related Technology

It is well recognized that synchronized transmissions of the same data over a single-frequency (frequency reuse factor 1) network provides significant performance benefits due to spatial macro-diversity for multicast and broadcast services (MBS), especially in terms of improving cell-edge throughput. In wireless communication, macro-diversity means a situation where several receiver antennas and/or transmitter antennas are used for transferring the same signal “synchronously” within the “same” frequency domain. The distance between the transmitters is longer than the wavelength. In Time-Division Duplex/Frequency Division Duplex (TDD/FDD) Orthogonal Frequency-Division Multiple Access (OFDMA), the support of synchronous transmission for macro diversity requires all BSs within the same macro diversity geographical area to synchronize the time period and location of transmission at the precision of the symbol level within the same subchannel.

The current IEEE 802.16-2004 standard as amended by IEEE 802.16e-2005, hereafter referred to as “the 802.16e standard” or simply “the standard” in the remainder of this document, provides such a synchronized mode of MBS transport service across multiple Base Stations (BSs). This mode of MBS is called “multi-BS MBS.” The 802.16e standard has further leveraged the synchronized MBS transmissions of this mode to facilitate the support of MBS data reception while the terminal is in a registered but idle state to maximize battery power savings when no other communications activities are required by the user for an extended period of time. During this idle state, known in the standard as Idle Mode, the terminal is not deemed to be “attached” to any particular BS for active service but can potentially move across the coverage area of multiple BSs without the knowledge of the network.

The spatial macro-diversity gain of synchronized MBS transmissions, however, is much reduced for higher order frequency networks, such as the commonly used reuse factor 3 and reuse factor 1/3 for the non-macro diversity networks, since the signal would be transmitted over different frequencies especially in adjacent Base Stations (BSs). In OFDMA, the channel bandwidth is subdivided into a group of orthogonal subchannels. For reuse factor 1/3, the group of subchannels is partitioned into three subgroups, and each subgroup is assigned to one of the three sectors or to a different BS. Therefore, in this type of network, synchronized transmissions are often not considered useful and consequently, not worth the additional implementation complexity. However, operating with MBS transmissions un-synchronized between BSs can result in a significant loss of power savings advantage for a mobile station (MS) that is meant to continue reception of MBS data while not otherwise engaged in other communications. This loss is due to the fact that the MS, when it crosses the coverage area between BSs, has to monitor the transmission signals closely to re-acquire the location of the pertinent MBS data transmissions at the new BS in order to maintain as good an MBS reception performance as possible.

The 802.16e standard defines a specific mode of multicast and broadcast operation where the same MBS traffic is sent simultaneously from a group of BSs. This mode of MBS operation is referred to as multi-BS MBS with the number of BSs>1, and this grouping of BSs is called an MBS Zone. The synchronized simultaneous transmission of the same MBS traffic from the BSs in an MBS Zone on a single carrier frequency provides the performance benefits gained via spatial macro-diversity as mentioned earlier.

A mobile station (MS) that wishes to start reception of particular MBS content over the air interface does so by setting up an MBS Media Access Control (MAC) connection with its serving BS. During the connection setup procedure, the MS is assigned the ID of an MBS MAC connection (known as a Multicast Connection ID, or MCID) to be used for reception of the subscribed content within a specific MBS Zone identified by an MBS Zone ID, if the connection is identified as operating in multi-BS MBS mode.

MBS traffic signals for multi-BS MBS connections are sent from the BS as data bursts within major time partitions of the downlink (DL) part of the MAC frame. These time partitions of the frame are referred to as permutation zones as they are distinguished by how subcarriers of the Orthogonal Frequency Division Multiplexed (OFDM) signal are distributed and grouped into subchannels. In another words, an MBS permutation zone is essentially a time partition within the frames that contains MBS data. There are one or more MBS data bursts in a permutation zone and one or more MAC Protocol Data Units (PDUs) in an MBS data burst.

Under the 802.16e standard, when operating with the OFDM Access (OFDMA) physical layer, the BSs transmit resource allocation information to the MSs through Media Access Protocol (MAP) messages that reside at the beginning of the downlink part of the frame. The MAP message used for transmitting downlink resource allocation information is the downlink-MAP (DL-MAP) message. A MAP message includes various information elements (IEs) that contain MAC frame control information. In particular, an MBS_MAP_IE may be present in the DL MAP message of a frame to specify where an MBS permutation zone (or MBS data) starts within the frame.

The MBS_MAP_IE specifies the starting point of an MBS permutation zone. Further details of the MBS permutation zone, including the structure, modulation and coding of MAC data bursts within the MBS permutation zone, are contained in an MBS MAP message. If present, the MBS MAP message always resides as the first data burst within an MBS permutation zone. The MBS MAP message contains IEs that describe the individual MBS data bursts that are present in MAC frames that are 2 to 5 frames in the future from the frame that contains the MBS MAP message itself.

The current method of directing an MS to the applicable MBS data bursts in an MBS permutation zone is illustrated in FIG. 1. As shown in FIG. 1, a plurality of successive frames 101, 102, 103, 104 . . . and 109 are sent by the BSs located in an MBS zone. When an MS has successfully established a specific multi-BS MBS MAC connection, it begins searching the DL MAP messages of those successive frames until it finds the first MBS_MAP_IE that describes the location of the next MBS permutation zone for the MBS Zone that the MBS MAC connection belongs to. The beginning of that MBS permutation zone should contain an MBS MAP message. For example, in FIG. 1, the DL MAP message of frame 101 contains an MBS_MAP_IE 111, which describes the location of an MBS permutation zone 100. The beginning of the MBS permutation zone 100 contains MBS MAP message 120.

On finding an MBS MAP message that contains a data burst allocation for an applicable MBS connection, the MS is provided sufficient information to locate, demodulate and decode the MBS data burst, and in addition, to locate the next occurrence of an MBS MAP message containing the next occurrence of a data burst for the MBS connection. In FIG. 1, MBS MAP message 120 contains three IEs 121, 122, and 123. These IEs can be MBS_DATA_IE, Extended_MBS_Data_IE, or MBS_Data_Time_Diversity_ID. IEs 121, 122, and 123 contain the addresses of MBS data bursts 131, 133, and 134, respectively. IE 121 also contains the address of the next MBS MAP Message 130 in frame 109 for the MBS MAC connections which the IE indicates MBS data for. Although not shown, IEs 122 and 123 also contain addresses of the next MBS MAP message(s) for the MBS MAC connections which these IEs indicate data for. Thus, once the MS finds MBS MAP message 120, it knows how to retrieve MBS data bursts 131, 133, and 134. In addition, the MS also knows how to find the next MBS MAP message 130.

The latter feature (that is, the chaining from an MBS MAP message to the next MBS MAP message(s) pertaining to the same MBS connections) enables efficient power saving operation when the MS is not otherwise active except to occasionally receive applicable MBS content because the MS is not required to continually monitor the DL MAP message of each frame searching for the next MBS MAP message for an applicable MBS connection. An MS in Idle Mode may traverse the coverage area of multiple BSs but can still efficiently locate the next relevant MBS MAP messages since it has been given the exact location of these MBS MAP messages and these locations are identical at any of these BSs as long as the BSs are part of the same MBS Zone. Therefore, the MS can remain essentially “powered off” as much as possible until it needs to awake in order to receive the next relevant MBS MAP message.

As discussed above, however, efficient power saving operation provided by the synchronized MBS transmissions is not always realized in higher order frequency networks, where synchronized transmissions are often not considered useful and consequently, not worth the additional implementation complexity. Therefore, there is a need for an improved method for implementing synchronized MBS transmissions that supports efficient power saving operation without the implementation complexity required by the current standard.

### SUMMARY OF THE INVENTION

Embodiments of the present invention are directed to synchronized transmissions of MBS data across neighboring BSs even for a higher order reuse network, such as the commonly used reuse factor 3 and reuse factor 1/3 network. The synchronized transmission of MBS data improves the support for power savings operation for mobile stations that receive MBS data during Idle Mode. The same concept of the synchronized transmission of MBS data across neighbor BSs even for the higher order reuse network as described above can also apply to the mobile stations performing handover operation in active mode.

A method is provided for frame-based synchronized transmission of MBS data. The method comprising: establishing an MBS MAC connection between a mobile station (MS) and a first base station (BS) in an MBS zone; sending a first MBS_MAP message in a first frame, wherein the first MBS_MAP message includes information for locating a second MBS_MAP message in a second frame, but does not specify the location of the second MBS MAP message within the second frame; and sending the second MBS_MAP message in the second frame.

In one embodiment, synchronization is to the level of a specific MAC frame, and the first MBS_MAP message specifies the frame offset of the second frame. In another embodiment, synchronization is within a range of frames from a specific MAC frame, and the first MBS_MAP message specifies the frame offset of a third frame that is the earliest frame of a range of frames containing the second frame, but does not specify the frame offset of the second frame. The second MBS_MAP message can be located by searching successive frames starting from the third frame for an information element (MBS_MAP_IE) that specifies the location of the second MBS_MAP message.

In yet another embodiment, a method is provided in which the MS tracks the elapsed time since the last MBS_MAP message so that it knows when to wake up to receive the next MBS_MAP message. The same tracking operation is also performed when the MS is in the active mode. The method comprising: establishing an MBS MAC connection between a mobile station (MS) and a first base station (BS) in an MBS zone; receiving a first MBS_MAP message in a first frame, wherein the first MBS_MAP message includes information for locating a second MBS_MAP message in a second frame, but does not specify the location of the second MBS MAP message within the second frame; determining a wake up time in preparation for the second frame; measuring the elapsed time; and preparing to receive the second frame at the wake up time. The wake up time is determined in part by how accurately the MS measures the lapsed time, and the MS validates the measured time by reading the frame number of the second frame.

### BRIEF DESCRIPTION OF THE DRAWINGS

FIG. 1 illustrates a conventional MBS data burst allocation method according to the current IEEE 802.16e standard.

FIGS. 2A and 2B illustrate a flow chart for an exemplary MBS operation according to an embodiment of the present invention.

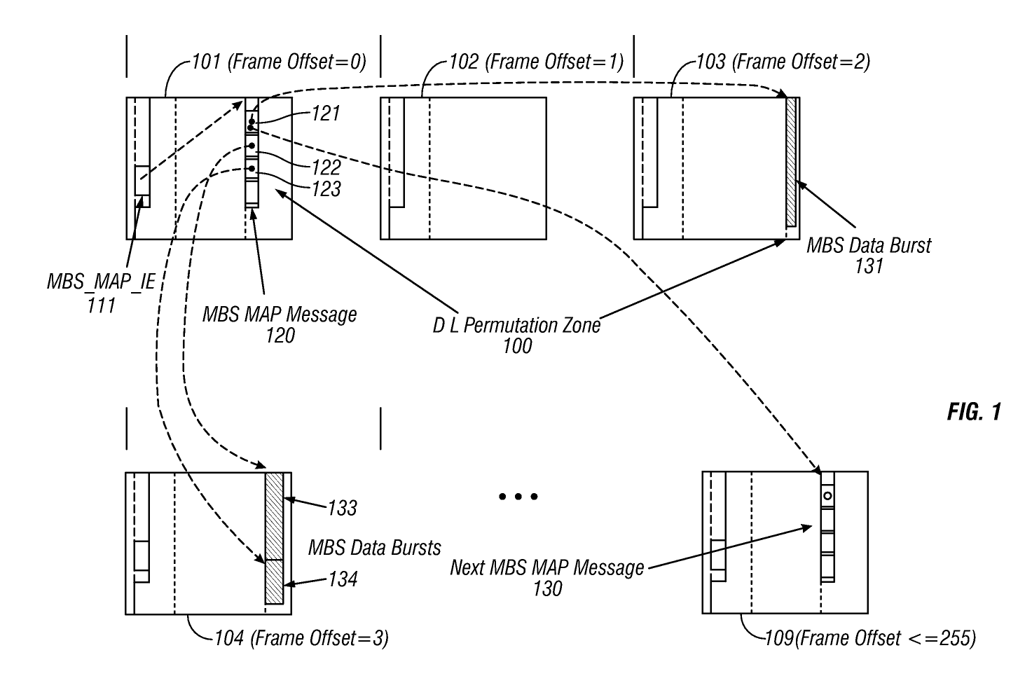

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

Although embodiments of the present invention are described herein in terms of a WiMAX network, it should be understood that the present invention is not limited to this application, but is generally applicable to any wireless network.

Embodiments of the present invention are directed to the use of synchronized transmissions of the same MBS data across neighboring BSs even for a higher order reuse network, such as the commonly used reuse factor 3 and reuse factor 1/3 network. A major reason for requiring a certain level of synchronization for a higher order frequency reuse network is to improve the efficiency of the timely reception of the MBS data during MS Idle Mode and Active Mode in 802.16 systems.

MBS operation as defined by the 802.16e standard provides an efficient method of receiving MBS data while the terminal is in Idle Mode. This is because the reception of an MBS MAP message that specifies the MBS data bursts for an MBS Zone over the next few frames also points to the next MBS MAP message for the same MBS connections. In this way, the terminal can return to a power-saving state between the reception of MBS data bursts and therefore, can maximize the power savings from being in Idle Mode while receiving MBS content. If this mechanism of chaining MBS MAP messages were not present, the terminal would need to continuously monitor the normal DL MAP of each frame in order to locate the next pointer to an MBS MAP message. Furthermore, when the MS is in active mode, rather than having the MS to perform the handover procedure to obtain the new MCID from the target BS to resume the reception of the MBS data, the MS can simply refer to the DL MAP to locate the next pointer to an MBS MAP that carries the same MBS data.

If the transmission of MBS MAP messages were not synchronized between neighboring BSs, the above method of chaining from one MBS MAP message to the next would become much less effective in terms of minimizing power drain as the MS would have to be awake for longer periods.

In terms of the standard, the only method of chaining MBS MAP messages involves specifying the exact location of the next MBS MAP message within a specific frame in the future (e.g., within 255 frames from the previous MBS MAP message). This can be referred to as strict synchronization.

To preserve as much battery power savings for the MS as possible while receiving MBS data in Idle Mode, synchronization of transmissions between BSs is necessary but this synchronization can be strict as supported by the current standard or can be somewhat looser, such as synchronization to the level of a specific MAC frame or to a range of MAC frames, with flexibility to be unsynchronized within those somewhat looser bounds. This latter “loose” synchronization is not currently supported in the standard at least for MBS MAP messaging chaining.

One criterion concerning whether MBS MAP message chaining operation can be preserved across carrier frequency changes in a higher-order frequency reuse network is whether the counting of consecutive frames can be preserved. In one embodiment of the present invention, this is achieved by a combination of synchronized frame numbering between BSs within the network, and with the MS tracking the elapsed time since the last MBS MAP message, which it can do even across carrier frequency changes. How accurate the MS internal timing is will determine how far in advance it will wake up in preparation for the next MBS MAP message. If needed, the MS can re-validate that it has measured the elapsed time sufficiently accurately by reading the frame count from the start of the frame which it believes contains the MBS MAP message and ensuring the frame number is what is expected based on the frame offset specified in the last MBS MAP message. If the opportunities arise, due to other wake-up events for standard Idle Mode operation, this interval timing accuracy validation procedure using the frame number can be done at intermediate points of time as well. It should be noted that this type of timing validation would need to take place regardless of whether the chaining operation was occurring in a single-frequency or multi-frequency network.

Given the MS ability to reach the specified frame for the next MBS MAP message based on the chaining information, placement of the MBS MAP message within the frame can be based on strict synchronization, as is currently supported in the standard, or on frame-based loose synchronization, which is currently not supported by the standard. Strict synchronization would provide some additional power savings since the MS would not have to process up to a substantial part of the DL-MAP looking for an MBS_MAP_IE that would specify the location of the MBS MAP message within the frame. Also, with strict synchronization, the network would not have to include an MBS_MAP_IE for each of MBS MAP message being sent and so would allow the network more leeway to perform a tradeoff to reduce the DL MAP overhead to support multi-BS MBS versus to reduce the latency for an MS to acquire or re-acquire access to the MBS data stream(s).

Strict synchronization would require no changes to the standard.

Two forms of frame-based loose synchronization are relevant to the present invention. In one form, synchronization is achieved to the level of a MAC frame and is referred to as frame-level synchronization. In the other form, synchronization is achieved to the level of a range of frames and is referred to as frame-range synchronization. Both frame-level synchronization and frame-range synchronization would require change to the standard.

The major consideration for operation with these frame-based loose synchronization methods is the support for the MBS MAP message chaining mechanism in order to retain as much efficiency in power savings at the MS as possible. Such support for both forms of frame-based loose synchronization can be achieved via a common set of protocol elements and procedures. Since synchronization is only achieved to the realm of a single frame or to a range of frames, the only required information to support MBS MAP message chaining is to identify a particular frame in the future at which the MS begins to look for the next relevant MBS MAP message. When information identifying such a frame is provided and frame-level synchronization is in effect, the MS would expect the next relevant MBS MAP message to occur within the identified future frame. Whereas when frame-range synchronization is in effect, the identified future frame would represent the earliest frame in which the MS can expect the next relevant MBS MAP message, and successive frames would be searched for the presence of the next relevant MBS MAP message until it is found. However, it would be a reasonable practice for the MS is implement behavior tailored for frame-range synchronization and apply it also to frame-level synchronization. The resulting behavior would provide recovery from errors in receiving the next relevant MBS MAP message at the expected frame by automatically searching for the subsequent relevant MBS MAP message if it failed to receive the relevant MBS MAP message in the expected frame.

There are two scopes of application of the synchronization methods in the operation within an MBS Zone. One scope is the synchronization method used within a BS which dictates the precision with which the time and frequency location of the next MBS MAP message that is transmitted by the BS for a certain set of MBS connections is known in advance. The other scope is the synchronization method used between BSs within the MBS Zone which dictates the precision with which the time and frequency location of the next MBS MAP message that is transmitted by a neighboring BS for a certain set of MBS connections is known in advance prior to the MS migrating to that neighboring BS.

According to one embodiment, the same synchronization method is applied to both scopes of application within an MBS Zone. This approach serves to minimize the control signaling and complexity required to realize both scopes of synchronization since only one set of synchronization parameters is needed to support synchronization both between BSs and within the BSs. This constraint results in the same level of synchronization being applied to all BSs within the MBS Zone which in turn means the same setting of synchronization parameters across all BSs within the MBS Zone. In the cases of frame-level and frame-range synchronization, this means that for any instance of a relevant MBS MAP message, the same frame is identified as the one in which the MBS MAP message is to be found or as the one in which to begin searching for the relevant MBS MAP message, respectively, across all BSs in the MBS Zone.

According to another embodiment, the synchronization method for each scope of application within an MBS Zone is set independently. This approach is the most flexible but requires a separate set of synchronization parameters to be maintained and communicated to the MS for each scope of application.

In one embodiment of the present invention, the definition of the MBS_DATA_IE, Extended_MBS_DATA_IE, and MBS_Time_Diversity_DATA_IE is changed so that the “Next MBS OFDMA Symbol Offset” field of the pointer to the next MBS MAP message is interpreted as not being included (e.g. such as defining a value of 0 to mean that no OFDMA Symbol Offset is provided). Thus, the chaining is based solely on identification, via the “Next MBS Frame Offset” field, of the next frame at which to begin search for the next relevant MBS MAP message. Such search would entail looking for the next relevant MBS MAC frame control information in the form of a relevant MBS_MAP_IE in the DL MAP of each successive frame starting from the frame identified by the chaining information from the previous MBS MAP message until a next MBS MAP message is found and received successfully. Similarly, the flag “Next MBS MAP change indication” is interpreted as not valid and set to a value of “0”.

In another embodiment of the present invention, a new attribute of the MBS Zone is defined to identify the synchronization level that is present within the MBS Zone. One value of such an attribute can indicate the use of strict synchronization that is amenable to macro-diversity within the MBS Zone. Another value of such an attribute can indicate the use of frame-based loose synchronization within the MBS Zone; in this case, the MS would be expected to re-acquire the location of the appropriate MAC frame and the appropriate MBS permutation zone within the MAC frame by searching for appropriate MAC frame control information, such as by searching for the relevant MBS_MAP_IE in the DL_MAP within successive frames, and reading this appropriate MAC frame control information to obtain the location of the relevant MBS permutation zone and MBS MAP message within the frame, when the MS reaches the identified frame to begin search for the next relevant MBS MAP message. When the value of the attribute indicates the use of frame-based loose synchronization, it would serve to invalidate the values of the “Next MBS OFDMA Symbol Offset” field of the pointer to the next MBS MAP message and of the flag “Next MBS MAP change indication” in MBS_DATA_IE, Extended_MBS_DATA_IE, or MBS_Time_Diversity_DATA_IE, and the valid next value of the OFDMA Symbol Offset for the appropriate MBS permutation zone would be re-acquired via the next relevant MBS_MAP_IE. In one embodiment, the attribute defining the level of synchronization within the MBS Zone has two values and can be represented as a 1-bit parameter. The value of this attribute may be conveyed to the MS in a number of ways. In one embodiment, the value of this attribute is associated with the MBS Zone via the same system broadcast information that conveys the MBS Zone identities to the MS, such as in the Downlink Channel Descriptor (DCD) MAC management message. In another embodiment, the value of this attribute is conveyed to the MS along with the MBS Zone identity for an MBS MAC connection as the connection is being set up or changed, such as in the Dynamic Service Addition (DSA) Request or Response MAC Management message, or the Dynamic Service Change (DSC) Request or Response MAC Management message.

While the invention has been described in the context of synchronization of MBS data transmissions within an MBS Zone, it can be equally applied to operation between any two MBS Zones for MBS content flows that are transmitted from both of these MBS Zones. In one embodiment, frame-level and/or frame-range synchronization is employed between two MBS Zones that carry MBS traffic for a common set of MBS MAC connections, but allowance is provided for a different frame within a range to be identified in the case of frame-level synchronization, as the frame in which the next relevant MBS MAP message is to be found or in the case of frame-range synchronization, as the starting frame from which to search for the frame containing the next relevant MBS MAP message. In one embodiment, such different frame in another MBS Zone is identified as a positive or negative offset in units of frames from the applicable frame in the current MBS Zone, and such offsets in the synchronization reference between MBS Zones is communicated to the MS as system broadcast information.

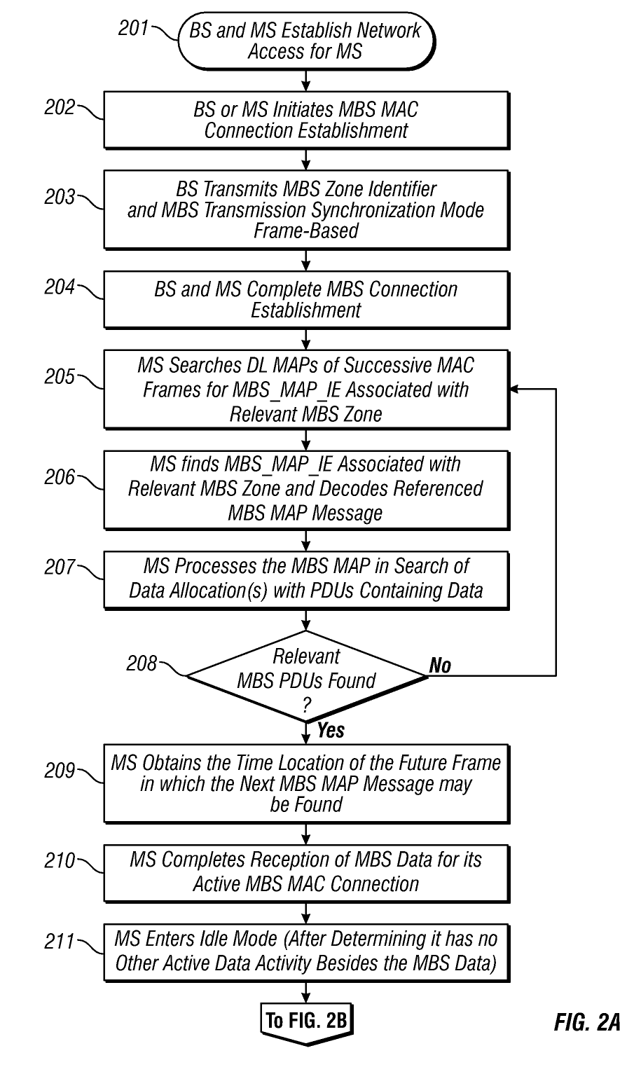

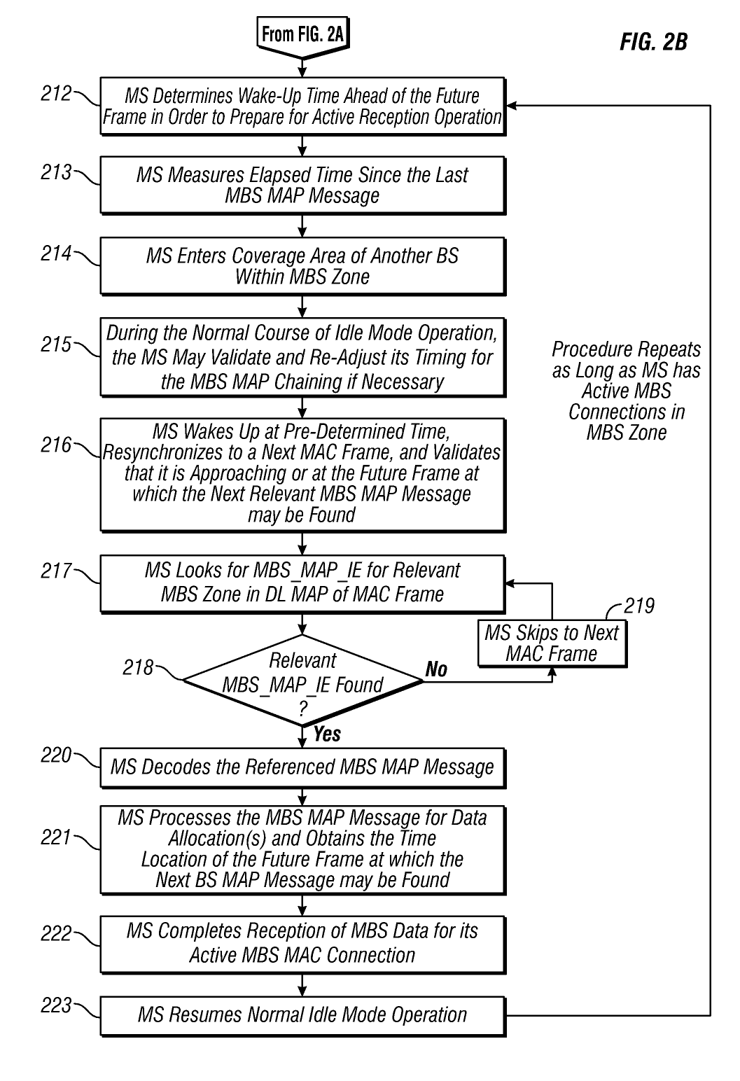

FIGS. 2A and 2B illustrate a flow chart for an exemplary MBS operation according to an embodiment of the present invention.

In step 201, an MS establishes network access via a BS in a MBS zone.

In step 202, the MS or BS initiates establishment of an MBS MAC connection to receive MBS content within the MBS zone.

In step 203, as part of the process of establishing the MBS MAC connection, the BS notifies the MS of the identifier associated with the MBS Zone in which the MBS content is transmitted and also the MBS transmission synchronization mode used within the MBS Zone; in this example, frame-based loose synchronization is identified as the applicable mode.

In step 204, the MS and BS successfully complete establishment of the MBS MAC connection.

In step 205, the MS searches the broadcast frame control information (DL MAPs) of successive MAC frames for an MBS_MAP_IE associated with the relevant MBS Zone.

In step 206, the MS finds a relevant MBS_MAP_IE that describes the location of the MBS permutation zone within the frame where the MBS MAP message for the relevant MBS Zone is located. The MS successfully decodes this MBS MAP message.

In step 207, the MS processes this MBS MAP message searching for one or more data resource allocations that contain one or more PDUs with data for the MS's active MBS MAC connection.

In step 208, if no data transmissions are found for the MS's active MBS MAC connection, the MS resumes the search from step 205; if data transmissions for the MS's active MBS MAC connection are found, then the MS proceeds to step 209,

In step 209, the MS obtains the time location of the future frame in which to look for the next MBS MAP message that contains data allocations for its active MBS MAC connection. An MBS_DATA_IE in the MBS MAP message has a “Next MBS Frame Offset” field that specifies a frame which represents the first future frame in which the next relevant MBS_MAP message may be sent. However, the MBS_DATA_IE does not specify the exact location of the next MBS MAP message within that frame. Both the “Next MBS OFDMA Symbol Offset” field and the “Next MBS MAP change indication” fields of the MBS_DATA_IE are set to a value of “0”.

In step 210, the MS completes reception of the MBS data for its active MBS MAC connection as specified by the data resource allocation information from the processed MBS MAP message.

In step 211, the MS enters Idle Mode operation after determining that it does not have any other active data activity besides the reception of MBS data. In Idle Mode, the MS is not deemed to be “attached” to any particular BS.

In step 212, the MS uses the frame offset specified in the MBS_DATA_IE to determine the time that the first future frame which may contain the next MBS_MAP message will occur. Depending on the accuracy of the MS's internal timing, the MS also determines how far in advance it will wake up in preparation for the next MBS MAP message (wake up time).

In step 213, the MS measures the elapsed time since the last MBS_MAP message.

In step 214, the MS enters the coverage area of a new BS in the MBS zone without the knowledge of the network.

In step 215, in a wake-up event not related to MBS, the MS receives a frame from the new BS. The MS validates that it has measured the elapsed time accurately by reading the frame count from the start of the frame and ensuring the frame number is what is expected. The MS may adjust the wake up time in accordance with the result of the validation.

In step 216, at the pre-determined wake-up time, the MS wakes up, resynchronizes to the next MAC frame and successfully validates that it is either at the future frame or approaching the future frame identified by the last MBS MAP message.

In step 217, the MS processes frame control information (DL MAP) read from the MAC frame and looks for a MBS_MAP_IE associated with the relevant MBS Zone.

In step 218, if the relevant MBS_MAP_IE is not found, the MS goes to the next MAC frame (step 219) and resumes searching via step 217.

In step 220, the MS has successfully found a relevant MBS_MAP_IE and then successfully decodes the MBS MAP message pointed to by the MBS_MAP_IE from the new BS. (Note that the MBS_MAP_IE and referenced MBS MAP message may be sent at the same frame time by the original BS and the new BS in the case of frame-level synchronization or may be sent at different frame times in the case of frame-range synchronization. The original BS and the new BS may transmit the frame over different frequencies.)

In step 221, the MS processes the decoded MBS_MAP message and obtains the time location of the future frame in which to look for the next MBS MAP message that contains data allocations for its active MBS MAC connection according to the same method as in step 208.

In step 222, the MS completes reception of the MBS data for its active MBS MAC connection as specified by the data resource allocation information from the processed MBS MAP message.

In step 223, the MS resumes normal Idle Mode operation.

Steps 212 to 223 are repeated to receive the next MBS data described by the next MBS MAP message for the active MBS MAC connection as long as the MBS MAC connection remains active.

While FIGS. 2A and 2B describe the exemplary operation when the MS enters Idle Mode, exemplary operation during Active Mode can be described by the same flow chart without steps 211, 212, 213, 215, 216, and 223, and with step 217 beginning at the future frame identified by the previous MBS MAP message in looking for the next relevant MBS MAP message.

Thus, in accordance with embodiments of the present invention, transmissions of MBS data are synchronized to the level of a frame or a range of frames. This level of synchronization is sufficient to provide improved terminal battery power savings for a terminal that is receiving MBS data while otherwise in an Idle state or in a active state, and being served by a network employing higher order frequency reuse or fractional frequency reuse without imposing the implementation complexity of strict synchronization that is necessary for macro-diversity operation in a single frequency network.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for providing a multicast and broadcast service (MBS) in a wireless network, the method comprising:
establishing an MBS MAC connection between a mobile station (MS) and a first base station (BS) in an MBS zone;
sending a first MBS_MAP message in a first frame, wherein the first MBS_MAP message includes information for locating a second MBS_MAP message in a second frame, but does not specify the location of the second MBS MAP message within the second frame; and
sending the second MBS_MAP message in the second frame.

2. The method of claim 1, wherein the first MBS_MAP message specifies the frame offset of the second frame, and the second frame includes an information element (MBS_MAP_IE) that specifies the location of the second MBS MAP message within the second frame.

3. The method of claim 1, wherein the first MBS_MAP message specifies the frame offset of a third frame that is the earliest frame of a range of frames containing the second frame, but does not specify the frame offset of the second frame.

4. The method of claim 3, further comprising searching successive frames starting from the third frame for an information element (MBS_MAP_IE) that specifies the location of the second MBS_MAP message.

5. The method of claim 1, further comprising invalidating a “Next MBS OFDMA Symbol Offset” field of an information element in the first MBS_MAP message.

6. The method of claim 5, further comprising invalidating a “Next MBS MAP change indication” field of the information element in the first MBS_MAP message.

7. The method of claim 5, wherein the information element is an MBS_DATA_IE.

8. The method of claim 5, wherein the information element is an Extended_MBS_DATA_IE.

9. The method of claim 5, wherein the information element is an MBS_Time_Diversity_DATA_IE.

10. The method of claim 1, further comprising defining an attribute that specifies a level of synchronization for MBS data transmissions.

11. The method of claim 10, wherein the attribute specifies a level of detail to which the location of the second MBS MAP message is indicated by the first MBS_MAP message.

12. The method of claim 11, wherein the level of detail is to a specific location within a MAC frame.

13. The method of claim 11, wherein the level of detail is to a specific MAC frame, but not to a specific location within the frame.

14. The method of claim 11, wherein the level of detail is to an earliest MAC frame in a range of frames containing the frame in which the next MBS data resource allocation message is located.

15. The method of claim 10, wherein the attribute specifies a level of synchronization for MBS data transmissions between BSs within the MBS Zone.

16. The method of claim 15, wherein the level of synchronization between BSs within the MBS Zone is amenable for macro-diversity operation within the MBS Zone.

17. The method of claim 15, wherein the level of synchronization between BSs within the MBS Zone is within the granularity of a MAC frame.

18. The method of claim 15, wherein the level of synchronization between BSs within the MBS Zone is to the granularity of a range of MAC frames.

19. The method of claim 10, wherein the attribute is specified separately for operation within a BS and operation between BSs within the MBS Zone.

20. The method of claim 10, wherein one instance of the attribute is commonly specified for operation within a BS and operation between BSs within the MBS Zone.

21. The method of claim 10, wherein the attribute is represented as a 1-bit parameter.

22. The method of claim 10, wherein the attribute is represented as a parameter larger than 1 bit.

23. The method of claim 20, wherein the attribute is associated with the MBS Zone.

24. The method of claim 23, wherein the attribute is conveyed along with the MBS Zone identity information as system broadcast information.

25. The method of claim 24, wherein the system broadcast information is a Downlink (DL) Channel Descriptor (DCD) MAC Management message.

26. The method of claim 23, wherein the attribute is conveyed along with the MBS Zone identity information during MBS MAC connection setup or change.

27. The method of claim 26, wherein MBS MAC connection setup occurs via the Dynamic Service Addition (DSA) Request or Response MAC Management message.

28. The method of claim 26, wherein MBS MAC connection change occurs via the Dynamic Service Change (DSC) Request or Response MAC Management message.

29. The method of claim 1, wherein the second frame is sent by the first BS and at least a second BS.

30. The method of claim 29, wherein the first BS and the second BS are located in the same MBS zone.

31. The method of claim 29, wherein the first BS and the second BS are located in different MBS zones.

32. The method of claim 29, wherein the second frame is sent by the first BS and the second BS simultaneously.

33. The method of claim 29, wherein the second frame is sent by the first BS at a specified offset in granularity of MAC frames from the transmission by the second BS.

34. The method of claim 29, wherein the first BS and the second BS send the second frame over the same frequencies.

35. The method of claim 29, wherein the first BS and the second BS send the second the frame over different frequencies.

36. The method of claim 35, wherein the wireless network is a higher-order frequency reuse network.

37. The method of claim 36, wherein the wireless network has a frequency reuse factor of 3.

38. The method of claim 36, wherein the wireless network is a fractional frequency reuse network.

39. The method of claim 38, wherein the wireless network is a frequency reuse factor of 1/3.

40. A method for providing a multicast and broadcast service (MBS) in a wireless network, the method comprising:
establishing an MBS MAC connection between a mobile station (MS) and a first base station (BS) in an MBS zone;
receiving a first MBS_MAP message in a first frame, wherein the first MBS_MAP message includes information for locating a second MBS_MAP message in a second frame, but does not specify the location of the second MBS MAP message within the second frame; and
determining a wake up time in preparation for the second frame;
measuring the elapsed time; and
preparing to receive the second frame at the wake up time.

41. The method of claim 40, wherein the wake up time is determined in part by how accurately the MS measures the lapsed time.

42. The method of claim 40, further comprising validating the elapsed time measured by the MS by reading the frame number of the second frame.

43. The method of claim 40, further comprising validating the elapsed time measured by the MS by reading the frame number of a frame between the first frame and the second frame.

44. The method of claim 43, further comprising adjusting the wake up time according to the result of the validation.

45. The method of claim 40, wherein the first MBS_MAP message specifies the frame offset of the second frame, and the second frame includes an information element (MBS_MAP_IE) that specifies the location of the second MBS MAP message within the second frame.

46. The method of claim 40, wherein the first MBS_MAP message specifies the frame offset of a third frame that is the earliest frame of a range of frames containing the second frame, but does not specify the frame offset of the second frame.

47. The method of claim 46, further comprising searching successive frames starting from the third frame for an information element (MBS_MAP_IE) that specifies the location of the second MBS_MAP message.

48. The method of claim 40, further comprising the MS entering an Idle Mode after receiving the first frame, and implementing battery power saving operation available in the Idle Mode until the wake-up time.

49. The method of claim 40, further comprising the MS receiving the second MBS_MAP message in the second frame without performing a handover procedure with the BS.

50. The method of claim 40, wherein the MS receives the first frame from the first BS, and receives the second frame from a second BS.

51. The method of claim 50, wherein the first BS and the second BS are located in the same MBS zone.

52. The method of claim 50, wherein the first BS and the second BS are located in different MBS zones.

53. The method of claim 50, wherein the second frame is sent by the first BS and the second BS simultaneously.

54. The method of claim 50, wherein the second frame is sent by the first BS at a specified offset in granularity of MAC frames from the transmission by the second BS.

55. The method of claim 50, wherein the first BS and the second BS send the second frame over the same frequencies.

56. The method of claim 50, wherein the first BS and the second BS send the second frame over different frequencies.

57. The method of claim 56, wherein the wireless network is a higher-order frequency reuse network.

58. The method of claim 57, wherein the wireless network has a frequency reuse factor of 3.

59. The method of claim 57, wherein the wireless network is a fractional frequency reuse network.

60. The method of claim 59, wherein the wireless network is a frequency reuse factor of 1/3.
